(19) United States
(12) Patent Application Publication
(10) Pub. No.: US 2015/0120442 A1
(43) Pub. Date: Apr. 30, 2015

(54) SYSTEMS AND METHODS FOR MOBILE ADVERTISING ON MULTI-SIM DEVICES

(71) Applicant: QUALCOMM Incorporated, San Diego, CA (US)

(72) Inventors: Shriram Ganesh, San Diego, CA (US); Jose R. Menendez, San Diego, CA (US)

(73) Assignee: QUALCOMM Incorporated, San Diego, CA (US)

(21) Appl. No.: 14/066,536

(22) Filed: Oct. 29, 2013

(51) Int. Cl. G06Q 30/02

(52) U.S. Cl. CPC G06Q 30/0255; G06Q 30/0267
USPC 705/14.53

(57) ABSTRACT

Systems and methods are disclosed for managing mobile advertisement in a smartphone that has multiple Subscriber Identification Module (SIM) capability to more effectively and more efficiently target mobile ads to smartphone users. Multi-SIM-capable devices such as DSDA devices have two subscriptions (e.g., two phone numbers) to one or more mobile telephony networks. One subscription may be used for personal use and the other subscription for work. The two SIM subscriptions and their characteristics may be considered when selecting the mobile ads to present to the users on the DSDA devices. Further, knowledge on the intended or actual use of the two subscriptions may be used to select, limit, adapt, or otherwise differentiate the mobile ads delivered to the user on the two subscriptions. The channel characteristics of the two SIM subscriptions may also be used to more efficiently deliver ads to the two SIM subscriptions.

### TECHNICAL FIELD

This application generally relates to managing advertisements on communication devices that implement multiple Subscriber identity Module (STM) subscriptions. In particular, this application relates to methods and systems to customize advertisements for each SIM subscription.

### BACKGROUND

Mobile advertising on mobile devices, such as smartphones, is increasingly used by advertisers to reach a wider audience of consumers. One advantage of mobile advertising over traditional advertising is that the mobile advertisements (ads) on smartphones may be narrowly tailored to the users of the smartphones. For example, mobile advertising networks such as AdMob for Android platform or iAds for iOS platform may use a targeting algorithm to select mobile ads deemed to be of interest to smartphone users based on information known about the users. Leveraging information about the users for targeted mobile advertising enables the advertisers to reach as many consumers as efficiently possible. Users benefit by being able to view ads that are of interest to the users. Developers of mobile applications may also use the mobile ads to monetize the apps.

Smartphones are identified by the smartphones' Subscriber Identity Module (SIM), which is used to identify and authenticate a subscription to a mobile telephony network. Smartphones with multiple SIM's are becoming popular. For example, some device manufacturers have customized the smartphones on the Android platform to add multi-SIM capability. Device manufacturers are also starting to introduce Dual-SIM-card, Dual-Access (DSDA) devices. On a DSDA device, there are two modems to support the two radio frequency (RF) channels used by the two subscriptions, with each subscription assigned to a separate phone number. For example, one subscription may be for personal use and the other subscription for work. On the DSDA device, there is one application processor and one High Level Operating System (HLOS) stack running the multi-STM solution. Nevertheless, the targeting algorithm does not consider the multi-SIM capability of the DSDA device. As such, advertisers may fail to efficiently target the mobile ads to the correct audience. For example, the targeting algorithm may deliver Not-Suitable-For-Work (NSFW) ads to the work subscription or may deliver work-related ads to the personal subscription. User experience may also suffer as users have to contend with unwanted ads. As such, there is a need for a system and method that effectively target advertisements to each SIM subscription of a multi-SIM communication device.

### SUMMARY

Systems and methods are disclosed for implementing a targeting algorithm in mobile advertising that uses the multi-SIM capability of smartphones to more effectively and more efficiently target mobile ads to smartphone users. Multi-STM-capable devices such as DSDA devices have two subscriptions (e.g., two phone numbers) to one or more mobile telephony networks. One subscription may be used for personal use and the other subscription for work. The targeting algorithm may consider the two subscriptions and their characteristics when selecting the mobile ads to present to the users on the DSDA devices. For example, users may indicate to the targeting algorithm how the users intend to use each subscription or the targeting algorithm may detect how the users actually used the subscriptions from usage patterns. The targeting algorithm may use knowledge on the intended or actual use of the two subscriptions to select, limit, adapt, or otherwise differentiate the mobile ads delivered to the user on the two subscriptions. For example, the targeting algorithm may limit the type of mobile ads on the work subscription so that the smartphone does not display NSFW ads when the work phone number is in use. In one or more embodiments, the targeting algorithm may limit the number of mobile ads delivered to the work phone number regardless of the level of activity on the work phone number. Thus, the work phone number may receive a limited number of ads, effectively putting the work phone number in a private mode. In one or more embodiments, the targeting algorithm may make the work phone number free of ads by delivering all ads to the personal phone number.

The targeting algorithm may also use the channel characteristics of the two subscriptions to more efficiently deliver ads to the two subscriptions. For example, the targeting algorithm may use a subscription channel having the smaller data bandwidth to receive banners or thumbnail sketches of ads in an app. The ads may be intended for display on either of the two subscriptions. The targeting algorithm may use the second subscription channel with a greater data bandwidth or both subscription channels to download the content of the ads from an ad hosting server. The app may combine the downloaded content from the two subscription channels to display the ads on the intended subscription, thus increasing the overall bandwidth for the ads. In one or more embodiments, the targeting algorithm may route all ads through the work subscription channel if it has more data bandwidth so as to conserve data bandwidth for the personal subscription channel. The ads may be displayed on either of the two subscriptions. In one or more embodiments, the smartphone may determine the received signal strength indicators (RSSIs) for the two subscription channels and the targeting algorithm may use the subscription channel with the stronger RSSI to download the ads intended for display on either of the two subscriptions. In one or more embodiments, the targeting algorithm may use the work subscription channel if it operates in a higher protected mode or with a more secure firewall for downloading or filtering the ads to gain increased security against virus, spyware, or malware embedded in the ads.

The mobile advertising network may charge for features that take advantage of the multi-SIM capability of the smartphones to more effectively and efficiently deliver mobile ads to smartphone users. Alternatively, the mobile advertising networks may offer the features free of charge in coordination with device manufacturers. The device manufacturers may also use these features to differentiate their multi-SIM smartphones from others.

A method for managing advertisements for a multi-SIM device is disclosed. The method may include receiving a request for an advertisement (ad) from an in-use SIM subscription on the multi-SIM device. The multi-SIM device is configured to implement multiple SIM subscriptions. The method also may include collecting parameters of the in-use SIM subscription and determining one or more ads based on the parameters. The ads are targeted for display on the in-use SIM subscription. Further, the method may include delivering the ads to the multi-SIM device for display on the in-use SIM subscription.

An apparatus is disclosed. The apparatus may include a memory and one or more processors that read the memory. The one or more processors may be configured to receive a request for an advertisement (ad) from an in-use SIM subscription on a multi-SIM device. The multi-SIM device is configured to implement multiple SIM subscriptions. The one or more processors also may be configured to collect parameters of the in-use SIM subscription and determine one or more ads based on the parameters. The ads are targeted for display on the in-use SIM subscription. Further, the one or more processors may be configured to deliver the ads to the multi-SIM device for display on the in-use SIM subscription.

A non-transitory computer-readable medium that stores machine-readable instructions for execution by a processor is disclosed. The processor may read the instructions to perform steps for managing advertisements for a multi-SIM device. The instructions may include steps to receive a request for an advertisement (ad) from an in-use SIM subscription on the multi-SIM device. The multi-SIM device is configured to implement multiple SIM subscriptions. The instructions also may include steps to collect parameters of the in-use SIM subscription and determine one or more ads based on the parameters. The ads are targeted for display on the in-use SIM subscription. Further, the instructions may include step to deliver the ads to the multi-SIM device for display on the in-use SIM subscription.

A system for managing advertisements for a multi-SIM device is disclosed. The system may include means for receiving a request for an advertisement (ad) from an in-use SIM subscription on the multi-SIM device. The multi-SIM device is configured to implement multiple SIM subscriptions. The system also may include means for collecting parameters of the in-use SIM subscription and determining one or more ads based on the parameters. The ads are targeted for display on the in-use SIM subscription. Further, the system may include means for delivering the ads to the multi-SIM device for display on the in-use SIM subscription.

### BRIEF DESCRIPTION OF THE DRAWINGS

FIG. 1 shows a system for managing advertisements on communication devices that implement multiple SIM subscriptions according to one embodiment of the subject matter of the present disclosure;

FIG. 2 shows a flowchart of a process for collecting advertisement customization parameters for a SIM subscription according to one embodiment of the subject matter of the present disclosure;

FIG. 3 shows a flowchart of a process for generating customized advertisements for a SIM subscription according to one embodiment of the subject matter of the present disclosure;

FIG. 4 is a block diagram of a computer system suitable for implementing advertisement customization for a SIM subscription according to one embodiment of the subject matter of the present disclosure.

Embodiments of the present disclosure and their advantages are best understood by referring to the detailed description that follows. It should be appreciated that like reference numerals are used to identify like elements illustrated in one or more of the figures.

### DETAILED DESCRIPTION

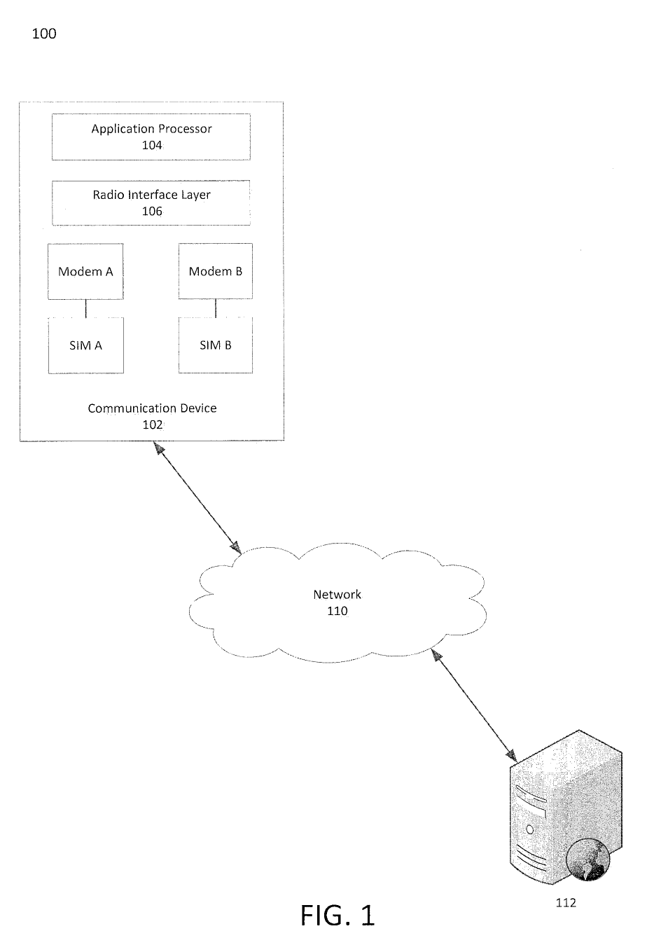

Systems and methods are disclosed for managing advertisements in a multi-SIM communication device. FIG. 1 is a networked system 100 configured to implement a process for managing advertisements displayed on a multi-SIM communication device 102. Networked system 100 may include a plurality of servers and/or software components that allow communication of information. Networked system 100 also may include other network devices that facilitate communication of information.

Networked system 100 may include an ad hosting server 112, a communication device 102, and a network 110. Ad hosting server 112 may store advertisement information, such as image files or HTML files. The advertisement information may be categorized into various topics based on consumer interest. Communication device 102 may request advertisements from ad hosting server 112. In response to the request, ad hosting server 112 may execute a targeting algorithm to select advertisements for communication device 112 and send advertisements via network 110 to communication device 102. Communication device 102 then may display the advertisements in an application or a web browser.

Network 110 may be a single network or a combination of multiple networks, e.g., the Internet. For example network 110 may include one or more intranets, landline networks, wireless networks, cellular networks, or the like. Ad hosting server 112 and communication device 102 may each include one or more processors, memories, and other appropriate components for executing program instructions stored on one or more computer readable mediums to implement various applications.

Communication device 102 may be implemented as a personal computer (PC), a smart phone, a personal digital assistant (PDA), a laptop computer, or other types of computing devices that are configured to receive and display information. Communication device 102 may include multiple SIM with multiple phone numbers associated with multiple SIM subscriptions. For example, communication device 102 may be a DSDA device that has two SIM's, SIM A and SIM B, associated two phone numbers, one for work and one for personal use. Communication device 102 also may include a modem A associated with SIM A and a modern B associated with SIM B. The modems may be configured to transmit and receive data over two RF channels—one modem and one RF channel for each SIM subscription.

An application processor 104 may run applications launched by a user from either of the two SIM subscriptions. Application processor 104 may run a targeting algorithm in conjunction with ad hosting server 112. In one or more embodiments, ad hosting server 112 may run the targeting algorithm based on information about the two SIM subscriptions and information about the user collected from communication device 102. The targeting algorithm may include a process 200 for collecting advertisement customization parameters and a process 300 for generating customized advertisements for a SIM subscription. A radio interface layer 106 running on the modems and application processor 104 may provide radio interface to application processor 104.

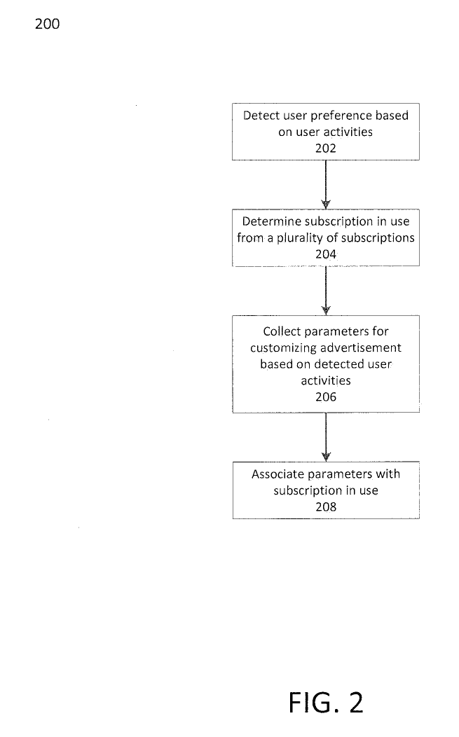

Referring to FIG. 2, process 200 for collecting advertisement customization parameters for a SIM subscription is shown in a flow chart. At step 202, communication device 102 may detect user preference based on user activities. For example, communication device 102 may determine the user's interests, preferences, demographics, and etc. based on user's interaction with communication device 102. In particular, communication device 102 may monitor apps downloaded, browsing history, web cookies, and/or purchases made by the user. For example, communication device 102 may determine that the user has an interest in sports if the user has downloaded sports themed apps, or that the user has a passion for a genre of music, movie, TV, audiobook, etc. from a history of online purchases or browsing history. Communication device 102 may also collect information on the characteristics of the SIM subscriptions such as their levels of activity, available data bandwidth, RSSIs, security features, etc. Further, communication device 102 may collect information such as the currently running app, the location of communication device 102, the device type, the hardware/software platform, and the type of the subscription network.

At step 204, communication device 102 may determine the SIM subscription that is currently being used by the user or that the user is intending on using. For example, communication device 102 may have a SIM subscription for work and a SIM subscription for personal use. Communication device 102 may determine which one of the two SIM subscriptions the user is using or is intending on using. Communication device 102 may determine the in-use SIM subscription from the applications that the use is operating. For example, communication device 102 may detect that the user is using an app associated with the work SIM subscription to review a work document and may determine that the in-use SIM subscription is the work SIM subscription. Communication device 102 may also determine the in-use SIM subscription from the user directly. For example, when the user starts a browser, communication device 102 may inquire the user which of the SIM subscriptions should be used to run the browser, and the user may indicate or choose one of the two SIM subscriptions to be the in-use SIM subscription.

Further, communication device 102 may determine the in-use SIM subscription based on a location of communication device 102. For example, communication device 102 may detect that communication device 102 is at the user's office and may determine that the in-use SIM subsection is the work SIM subscription. In an embodiment, multiple SIM subscriptions may concurrently be the in-use SIM subscription. For example, the user may run a work email application using the work SIM subscription and a news application using the personal SIM subscription concurrently.

At step 206, communication device 102 may generate or update user parameters for customizing advertisements for the in-use SIM subscription based on the detected user activities. The user parameters may include a plurality of categories and topics pertaining to the user's interests, preferences, patterns, etc. The user may also specify the parameters or how the user wishes to use the in-use SIM subscription. Further, SIM subscription parameters such as each SIM subscription's level of activity, available data bandwidth, Received Signal Strength Indicators (RSSI), security features, etc. also maybe generated or updated. In addition, device parameters such as the currently running app, the location of communication device 102, the device type, the hardware/software platform, and the type of the subscription network also may be generated or updated.

At step 208, communication device 102 may store or associate the set of generated or updated parameters with the in-use SIM subscription in which the parameters are detected. For example, parameters generated from user activities occurred when the in-use SIM subscription is the work SIM subscription may be associated with the work SIM subscription. Accordingly, the above process 200 may allow different sets of parameters to be generated for different SIM subscriptions. Each SIM subscription may have its own unique set of parameters for customizing advertisements for that SIM subscription. In an embodiment, multiple SIM subscriptions may be in-use concurrently. Parameters generated for each in-use SIM subscription may be associated with the respective in-use SIM subscription. For example, assuming that a work SIM subscription and a personal SIM subscription are in-use simultaneously to run a work related application and a personal shopping application respectively. User preferences received in the work related application using the work SIM subscription may be associated with the work SIM subscription and browsing history generated in the personal shopping application using the personal SIM subscription may be associated with the personal SIM subscription.

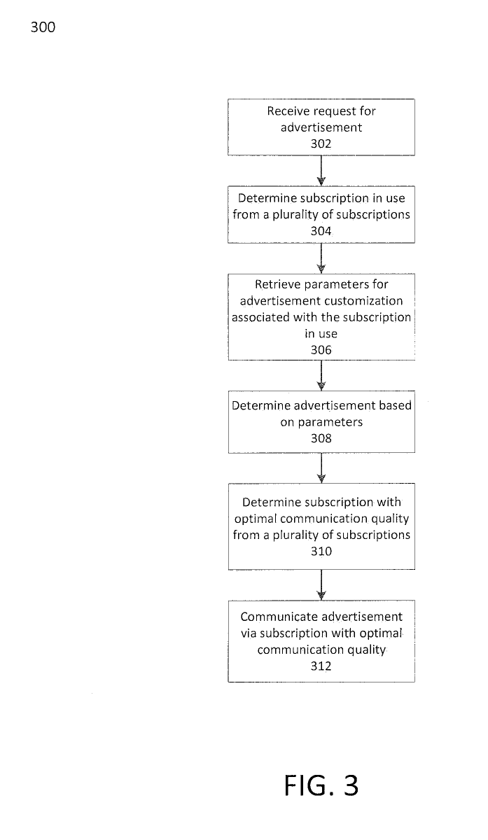

Referring to FIG. 3, a process 300 for generating customized advertisements for a SIM subscription according to one embodiment of the subject matter of the present disclosure is shown in a flow chart. At step 302, a request for advertisements may be received at ad hosting server 112. For example, a user may install an app at communication device 102. The app may have signed up with a mobile advertising network to use the app as a vehicle to display mobile ads at communication device 102. When the user launches the app on an SIM subscription, the app may send a request to ad hosting server 112 requesting advertisements for display in the app.

At step 304, the SIM subscription being used by the user may be determined. As noted in step 204, the SIM subscription in-use may be determined by based on the application being executed by communication device 102 or by a location of communication device 102. For example, if the application being executed is a game app associated with the personal SIM subscription, the SIM subscription in-use may be the personal SIM subscription. In one embodiment, the user may designate or select the SIM subscription in-use from two or more SIM subscriptions. In still another embodiment, multiple SIM subscriptions may simultaneously be in-use.

At step 306, parameters associated with the SIM subscription in-use may be retrieved. As noted above in process 200, different sets of parameters pertaining to the user's interests, preferences, patterns, etc. may be associated with different SIM subscriptions. The parameters that are associated with the SIM subscription in-use may be retrieved. For example, when the SIM subscription in-use is the SIM subscription for work, the parameters related to work and productivity may be retrieved, while parameters related to personal preference in music and game may not be retrieved if the personal SIM subscription is not in-use.

At step 308, advertisements may be determined or selected based on the parameters associated with the SIM subscription in-use. For example, if the SIM subscription in-use is a work SIM subscription, the user parameters associated with the work SIM subscription, such as user preferences related to work and productivity, may be used to select advertisements for the work SIM subscription. Thus, different sets of user parameters may be used to determine the ads for different SIM subscriptions. For example, on a SIM subscription for work, user parameters related to the user's interests in genres of music, movie, e-book, etc. may not be used to determine the ads for the work subscription. Thus, types of advertisements for the work SIM subscription may be limited. In one or more embodiments, the number of ads delivered to the work SIM subscription may be limited regardless of the level of activity on the work SIM subscription. Thus, the work SIM subscription may receive a limited number of ads, effectively putting the work SIM subscription in a private mode. In one or more embodiments, the work SIM subscription may be free of ads by delivering all ads to non-work SIM subscription. In an embodiment, multiple SIM subscriptions may concurrently be in-use. Different sets of advertisements may be determined and selected separately for respective SIM subscriptions.

At step 310, a SIM subscription with optimal communication quality may be determined. For example, although advertisements are generated for the SIM subscription in-use, the advertisements may be delivered from ad hosting server 112 to communication device 102 via a different SIM subscription with better communication quality. SIM subscription parameters, such as each SIM subscription's level of activity, available data bandwidth, RSSIs, security features, etc. may be compared to determine the SIM subscription with the best communication quality. For example, a SIM subscription with better signal strength or greater bandwidth may be selected to communicate the advertisements to the SIM subscription in-use.

At step 312, the generated or selected advertisements for the SIM subscription in-use may be transmitted from ad hosting server 112 to communication device 102 via one or more SIM subscriptions with optimal communication quality. For example, ad hosting server 112 may transmit Universal Resource Locators (URL) and/or the content of the ads to communication device 102 through one or more of the SIM subscription channels, not just the channel for the SIM subscription in-use. In an embodiment, a greater amount of ads may be delivered via a SIM subscription with better communication quality, e.g., greater bandwidth or greater signal strength, than via a SIM subscription with less communication quality. The URLs, banners, or the thumbnail sketches of the ads may be displayed on the app or browser executed at communication device 102. When the user selects to view the ads, the communication device 102 may download the selected ads from ad hosting server 112 or may retrieve the selected ads from memory if the ads have previously been downloaded. Thus, communication device 102 may display the ads, enabling advertisers to effectively and efficiently deliver targeted ads to the user on each SIM subscription of the multi-SIM communication device 102.

The steps in the above processes 200 and 300 may be executed by communication device 102. In an embodiment, the steps may be executed by ad hosting server 112. In still another embodiment, one or more steps may be executed at communication device 102 while the other steps may be executed at ad hosting server 112.

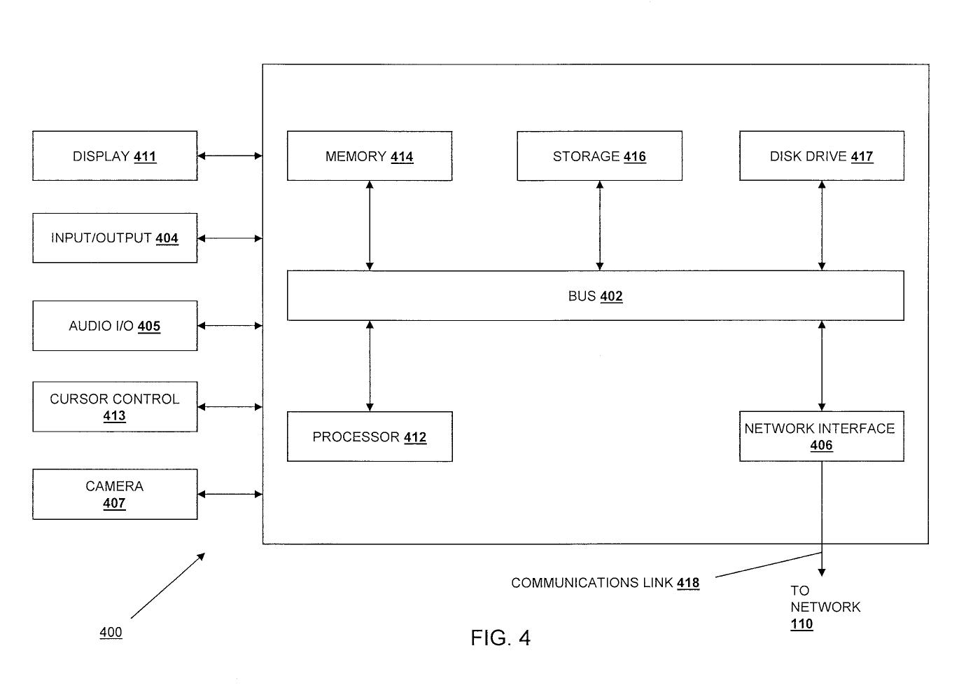

FIG. 4 is a block diagram of a computer system 400 suitable for managing advertisements for a multi-SIM communication device according to one embodiment of the subject matter of the present disclosure. Computer system 400 may comprise or implement a plurality of hardware components and/or software components that operate to perform various methodologies in accordance with the described embodiments.

Computer system 400 may include a bus 402 or other communication mechanism for communicating data, signals, and information between various components of computer system 400. Components may include an input/output (I/O) component 404 that processes user action, such as detecting users scrolling actions in an application, clicking on links or entering URLs of webpages, etc., and sends a corresponding signal to bus 402. I/O component 404 may also include an output component such as a display 411 for displaying the browser window, an input component such as a camera 407, and an input control such as a cursor control 413 (such as a virtual keyboard, virtual keypad, virtual mouse, etc.). An optional audio input/output component 405 may also be included to allow a user to use voice for inputting information by converting audio signals into information signals. Audio I/O component 405 may allow the user to hear audio. A transceiver or network interface 406 may transmit and receive signals between computer system 400 and other devices, such as another communication device, or another network computing device via a communication link 418 to a network. In one embodiment, the transmission is a cellular/wireless communication, although other transmission mediums and methods may also be suitable. A processor 412, which may comprise a micro-controller, digital signal processor (DSP), or other processing component, processes these various signals, such as for display on computer system 400 or transmission to other devices via communication link 418. Processor 412 may also control transmission of information, such as cookies or IP addresses, to other devices.

Components of computer system 400 also may include a system memory component 414 (e.g., RAM), a static storage component 416 (e.g., ROM), and/or a disk drive 417. Computer system 400 may perform specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical, or magnetic disks, or solid-state drives, such as storage component 416 or disk drive 417; volatile media includes dynamic memory, such as system memory component 414; and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN. WLAN, PTSN, and/or various other wired or wireless networks, including telecommunications, mobile, and cellular phone networks) may perform instruction sequences to practice the present disclosure in coordination with one another.

For example, instructions for managing and customizing advertisements for a multi-SIM communication device may be stored in the computer readable medium of system memory component 414, storage component 416, or disk drive 417 for execution by processor 412. Processors may execute the instructions to determine the SIM subscription in-use and a SIM subscription with optimal communication channel. Processors may also execute the instructions to select and customize advertisements for the SIM subscription in-use based on parameters associated with the SIM subscription in-use.

Where applicable, various embodiments provided by the present disclosure may be implemented using hardware, software, firmware, or combinations thereof Also where applicable, the various hardware components, software components, and/or firmware components set forth herein may be combined into composite components comprising software, firmware, hardware, and/or all without departing from the spirit of the present disclosure. Where applicable, the various hardware components, software components, and/or firmware components set forth herein may be separated into sub-components comprising software, firmware, hardware, or all without departing from the spirit of the present disclosure. In addition, where applicable, it is contemplated that software components may be implemented as hardware components, and vice-versa. Where applicable, the ordering of various steps described herein may be changed, combined into composite steps, and/or separated into sub-steps to provide features described herein.

Although embodiments of the present disclosure have been described, these embodiments illustrate but do not limit the disclosure. For example, although the information metrics are computed from histograms of gradient magnitudes, embodiments of the present disclosure may encompass metrics based on other measures of information content such as the types of multimedia elements presented. It should also be understood that although the priority of rendering is shown as based on information metrics of content contained in fixed size tiles, embodiments of the present disclosure may encompass prioritizing the rendering based on other criteria set by the web browser or configured by users, in contents contained in tiles that are variable in size. It should also be understood that embodiments of the present disclosure should not be limited to these embodiments but that numerous modifications and variations may be made by one of ordinary skill in the art in accordance with the principles of the present disclosure and be included within the spirit and scope of the present disclosure as hereinafter claimed.

What is claimed is:

1. A method, comprising:
receiving, by a processor, a request for an advertisement (ad) from an in-use Subscriber Identity Module (SIM) subscription on a multi-SIM device configured to implement multiple SIM subscriptions;
collecting, by the processor, parameters of the in-use SIM subscription;
determining, by the processor, one or more ads based on the parameters, wherein the ads are targeted for display on the in-use SIM subscription; and
delivering by the processor the ads to the multi-SIM device for display on the in-use SIM subscription.

2. The method of claim 1, wherein the parameters used to determine the ads are different for different SIM subscriptions that become the in-use SIM subscription.

3. The method of claim I, wherein the parameters comprise information that the in-use SIM subscription is used for a purpose selected from one of work use and personal use.

4. The method of claim 3, wherein said determining by the processor one or more ads based on the parameters comprises differentiating the ads targeted for display on the in-use SIM subscription used for work from the ads targeted for display on the in-use SIM subscription used for personal use.

5. The method of claim 4, wherein said determining by the processor one or more ads based on the parameters further comprises limiting the type of ads targeted for display on the in-use SIM subscription when the in-use SIM subscription is used for work.

6. The method of claim 4, wherein said determining by the processor one or more ads based on the parameters further comprises limiting the number of ads targeted for display on the in-use SIM subscription when the in-use SIM subscription is used for work.

7. The method of claim 1, further comprising collecting by the processor parameters of a second SIM subscription other than the in-use SIM subscription.

8. The method of claim 7, wherein said delivering by the processor the ads to the multi-SIM device comprising selecting one or more of channels associated with the in-use SIM subscription and the second SIM subscription to deliver the ads based on the parameters of the in-use SIM subscription and the parameters of the second SIM subscription.

9. The method of claim 8, wherein said delivering by the processor the ads to the multi-SIM device further comprises delivering the ads through the channel associated with the in-use SIM subscription or the second SIM subscription that has more data bandwidth.

10. The method of claim 8, wherein said delivering by the processor the ads to the multi-SIM device further comprises delivering more of the ads through the channel associated with the in-use SIM subscription or the second SIM subscription that has more data bandwidth.

11. An apparatus, comprising:
a processor;
a memory adapted to store a plurality of machine-readable instructions which when executed by the processor are adapted to cause the apparatus to run a targeting application to:
receive a request for an advertisement (ad) from an in-use SIM subscription on a multi-SIM communication device configured to implement multiple SIM subscriptions;
collect parameters of the in-use SIM subscription.
determine one or more ads based on the parameters, wherein the ads are targeted for display on the in-use SIM subscription; and
deliver the ads to the multi-SIM device for display on the in-use SIM subscription.

12. The apparatus of claim 11, wherein the parameters used to determine the ads are different for different SIM subscriptions that become the in-use SIM subscription.

13. The apparatus of claim 11, wherein the parameters comprise information that the in-use SIM subscription is used for a purpose selected from one of work use and personal use.

14. The apparatus of claim 13, wherein the machine-readable instructions when executed by the processor to determine one or more ads based on the parameters are further adapted to cause the targeting application to differentiate the ads targeted for display on the in-use SIM subscription used for work from the ads targeted for display on the in-use SIM subscription used for personal use.

15. The apparatus of claim 14, wherein the machine-readable instructions when executed by the processor to determine one or more ads based on the parameters are further adapted to cause the targeting application to limit the type of ads targeted for display on the in-use SIM subscription when the in-use SIM subscription is used for work.

16. The apparatus of claim 14, wherein the machine-readable instructions when executed by the processor to determine one or more ads based on the parameters are further adapted to cause the targeting application to limit the number of ads targeted for display on the in-use SIM subscription when the in-use SIM subscription is used for work.

17. The apparatus of claim 11, wherein the machine-readable instructions are further adapted to cause the targeting application to collect parameters of a second SIM subscription other than the in-use SIM subscription.

18. The apparatus of claim 17, wherein the machine-readable instructions when executed by the processor to deliver the ads to the multi-SIM device are further adapted to select one or more of channels associated with the in-use SIM subscription and the second SIM subscription to deliver the ads based on the parameters of the in-use SIM subscription and the parameters of the second SIM subscription.

19. The apparatus of claim 18, wherein the machine-readable instructions when executed by the processor to deliver the ads to the multi-SIM device are further adapted to deliver the ads through the channel associated with the in-use SIM subscription or the second SIM subscription that has more data bandwidth.

20. A non-transitory computer-readable medium comprising a plurality of machine-readable instructions which, when executed by one or more processors, are adapted to cause the one or more processors to perform a method comprising:
receiving a request for an advertisement (ad) from an in-use SIM subscription on a multi-SIM communication device configured to implement multiple SIM subscriptions;
collecting parameters of the in-use SIM subscription.
determining one or more ads based on the parameters, wherein the ads are targeted for display on the in-use SIM subscription; and
delivering the ads to the multi-SIM device for display on the in-use SIM subscription.
